(19) United States
(12) Patent Application Publication
(10) Pub. No.: US 2004/0152515 A1
(43) Pub. Date: Aug. 5, 2004

(54) Cordless game controller system

(75) Inventors: David Wegmuller, Union City, CA (US); Fred Swan, Castro Valley, CA (US)

Correspondence Address: Townsend and Townsend and Crew LLP, 8th Floor, Two Embarcadero Center, San Francisco, CA, 94111, US

(73) Assignee: Logitech Europe S.A., Romanel-sur Morges (CH)

(21) Appl. No.: 10/359,735

(22) Filed: Feb. 5, 2003

(51) Int. Cl. A63F 13/02

(52) U.S. Cl. 463/36

(57) ABSTRACT

Embodiments of the present invention are directed to interfacing a plurality of user manipulable input devices with a host device using a more simplified and convenient setup for the user. In one embodiment, a system of user manipulable devices for interfacing with a host device comprises a first user manipulable device which is configured to be operatively connected with the host device to interface with the host device to transfer data between the first user manipulable device and the host device and produce sensory feedback to a user. A second user manipulable device is configured to interface wirelessly with the first user manipulable device to transfer data between the second user manipulable device and the host device via the first user manipulable device and produce sensory feedback to the user. The first user manipulable device and the second user manipulable device are manipulable by the same user.

### BACKGROUND OF THE INVENTION

This invention relates generally to user manipulable devices and systems and, more particularly, to a system of user manipulable devices configured to interface with a host device to produce sensory feedback to the user.

Multiple input devices or peripheral devices can be used to transmit input signals to a host device such as a PC. In some cases, an input device has two pieces that work together to generate an input, such as a steering wheel console and a set of pedals, or a joystick and a throttle. When the steering wheel is used, the user has to install the console on the desk and push away the keyboard. The user also has to connect the console to the pedals and to the host device. Depending on the wiring scheme and the location of the host device, this task can be tedious. Cords and wires connecting the input devices can also be cumbersome and inconvenient, and get in the way of the user.

### BRIEF SUMMARY OF THE INVENTION

Embodiments of the present invention are directed to interfacing a plurality of user manipulable input devices with a host device using a more simplified and convenient setup for the user. The invention does so by providing a wireless connection between the user manipulable devices and a wired connection between one user manipulable device and the host device. The data or signals generated in the user manipulable devices are transferred to the host device via the wired connection. The wireless connection between the user manipulable devices simplifies the setup of the system and provides greater freedom and convenience to the user.

In accordance with an aspect of the present invention, a system of user manipulable devices for interfacing with a host device comprises a first user manipulable device which is configured to be operatively connected with the host device to interface with the host device to transfer data between the first user manipulable device and the host device and produce sensory feedback to a user. A second user manipulable device is configured to interface wirelessly with the first user manipulable device to transfer data between the second user manipulable device and the host device via the first user manipulable device and produce sensory feedback to the user. The first user manipulable device and the second user manipulable device are manipulable by the same user.

In some embodiments, the first user manipulable device is configured to process the data received from the second user manipulable device and present the data of the first and second user manipulable devices to the host device as signals from a single device. The first user manipulable device is configured to be connected to the host device to receive power from the host device. The first user manipulable device may be configured to be connected to the host device via a USB connection. The second user manipulable device may be configured to interface wirelessly with the first user manipulable device by infrared, radio frequency, or ultrasound. The sensory feedback may comprise at least one of visual feedback, audio feedback, and force feedback. The second user manipulable device may be cordless.

In accordance with another aspect of the invention, a system of user manipulable devices for interfacing with a host device comprises a first user manipulable device which is configured to be operatively connected with the host device to interface with the host device to transfer data between the first user manipulable device and the host device and produce sensory feedback to a user. A second user manipulable device is configured to interface wirelessly with the first user manipulable device to transfer data between the second user manipulable device and the host device via the first user manipulable device and produce sensory feedback to the user. The first user manipulable device and the second user manipulable device are game controller devices for playing a game in the host device by the user.

In some embodiments, the first user manipulable device is configured to be connected to the host device via a wired connection. The first user manipulable device may comprise one of a wheel and a pedal apparatus, and the second user manipulable device may comprise another one of the wheel and the pedal apparatus. The first user manipulable device may comprise one of a joystick and a throttle, and the second user manipulable device may comprise another one of the joystick and the throttle.

In accordance with another aspect of the present invention, a method of interfacing with a host device via a plurality of user manipulable devices comprises transmitting data generated in a second user manipulable device by a user to a first user manipulable device wirelessly; transmitting data generated in the first user manipulable device by the user and the data received from the second user manipulable to the host device via a wired connection between the first user manipulable device and the host device; and processing the data received by the host device from the first user manipulable device via the wired connection to provide sensory feedback to the user.

### BRIEF DESCRIPTION OF THE DRAWINGS

FIG. 1 is a block diagram of a system of user manipulable devices for interfacing with a host device according to an embodiment of the present invention;

FIG. 2 is a block diagram of a system of user manipulable devices for interfacing with a host device according to an embodiment of the present invention;

FIG. 3 is a block diagram of a system of user manipulable devices for interfacing with a host device according to an embodiment of the present invention; and

FIG. 4 is a block diagram of a system of user manipulable devices for interfacing with a host device according to an embodiment of the present invention.

### DETAILED DESCRIPTION OF THE INVENTION

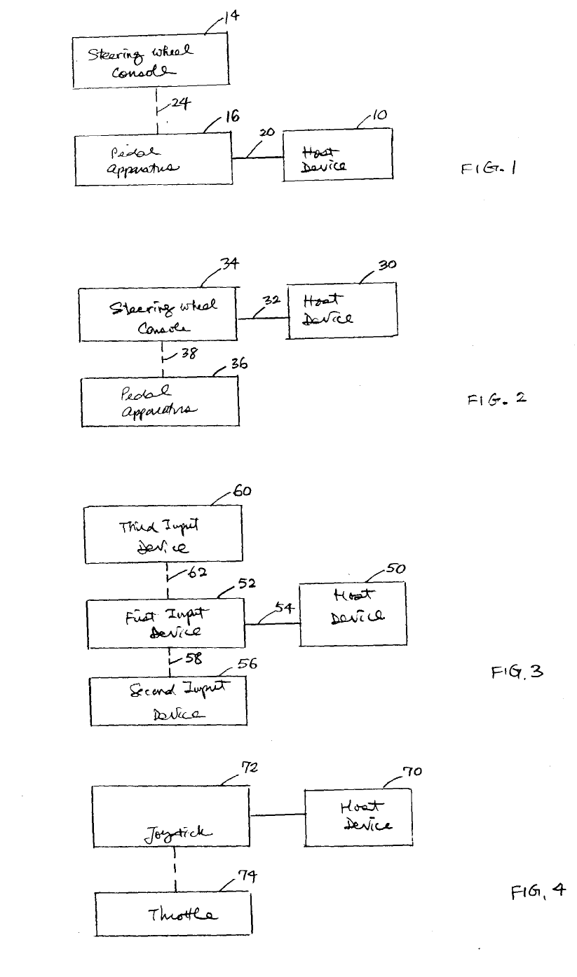

FIG. 1 shows a block diagram of a system of user manipulable input devices configured to interface with a host device 10. The host device 10 may be a PC or the like having a processor for processing data or signals received from the input devices. FIG. 1 shows two input devices but it is understood that the system may include additional input devices.

In FIG. 1, a steering wheel system includes a steering wheel console 14 and a pedal apparatus 16 having one or more pedals. Typically, the pedal apparatus 16 includes an accelerator pedal and a brake pedal which are rotatably supported on a base. The steering wheel console 14 typically includes a wheel rotatably supported on the console and may include additional buttons, switches, or the like for generating input by the user. The pedal apparatus 16 is connected to the host device 10 by a wired connection 20 for data transfer therebetween. The wired connection 20 may be configured to transfer power from the host device 10 to the pedal apparatus 16 in addition to facilitating data transfer between the host device 10 and the pedal apparatus 16, such as a USB connection or the like.

The steering wheel console 14 interfaces with the pedal apparatus 16 via a wireless connection 24 to permit data transfer therebetween. For instance, the steering wheel console 14 has a cordless radio transmitter and the pedal apparatus 16 includes a cordless radio receiver. Input signals generated by the user are transmitted from the wheel console 14 to the pedal apparatus 16 by radio frequency. Examples of other types of wireless transmission include infrared, ultrasound, and the like. The steering wheel console 14 desirably includes a battery as the power source so that the console 14 is cordless. In this way, the cordless console can be moved about freely without concern for cables and cords. Alternatively, the console 14 may be connected to a power source such as an AC power supply.

The input signals received by the pedal apparatus 16 from the steering wheel console 14 and the input signals of the pedal apparatus 16 generated by the user are transferred to the host device via the wired connection 20. The input signals are generated by the hands and foot of the same user operating both the steering wheel console 14 and the pedal apparatus 16 to play a game in the host device 10. Typically, the game software is encoded to accept input from a single game controller device. In this case, the signals received from the steering wheel console 14 by the pedal apparatus 16 may be processed and be presented with the signals generated in the pedal apparatus 16 to the host device 10 as signals from a single device.

The host device 10 processes the input signals received through the wired connection 20, and produces sensory feedback to the user, such as visual feedback, audio feedback, force feedback, or the like. The visual feedback and audio feedback may be provided by a screen display and speakers. The force feedback may involve forces generated by force feedback motors present in the input devices.

In FIG. 2, the host device 30 is connected to the steering wheel console 34 via a wired connection 32, while the pedal apparatus 36 communicates with the steering wheel console 34 via a wireless connection 38. The input signals generated in the pedal apparatus 36 is transmitted to the steering wheel console 34 via the wireless connection 38. The console 34 transfers the input signals of the pedal apparatus 36 and the input signals generated in the steering wheel console 34 to the host device 30 through the wired connection 32. The pedal apparatus 36 desirably includes a battery as the power source so that the pedal apparatus 36 is cordless. Alternatively, the pedal apparatus 36 may be connected to a power source such as an AC power supply.

If a force feedback motor is provided in the steering wheel console 14 in the system shown in FIG. 1, a large battery will need to be installed in the steering wheel console 14 to make it cordless. This will increase the weight and size of the console 14, which may not be desirable. If a force feedback motor is provided in the pedal apparatus 36 in the system of FIG. 2, a large battery will need to be installed in the pedal apparatus 36 to render it cordless. This will increase the weight but not necessarily the size of the pedal apparatus 36, since there is typically substantial empty space in the pedal apparatus to install a large battery. The increase in weight will typically be beneficial for the pedal apparatus 36 since it makes the pedal apparatus 36 more stable during game play.

FIG. 3 shows another system in which the host device 50 is connected to a first input device 52 via a wired connection 54. A second input device 56 is connected to the first input device 52 via a wireless connection 58. Additional input devices may be provided. For instance, a third input device 60 is also connected to the first input device 52 via a wireless connection 62. Signals generated by the second input device 56 and third input device 60 are transmitted to the first input device 52, which transfers those input signals as well as the input signals generated in the first input device 52 to the host device via the connection 54. One example of other input devices includes a joystick 72 and a throttle 74, which can be used together to play a game in the host device 70 as illustrated in FIG. 4.

The above-described arrangements of apparatus and methods are merely illustrative of applications of the principles of this invention and many other embodiments and modifications may be made without departing from the spirit and scope of the invention as defined in the claims. For instance, the connection between the first input device and the host device may be wireless. Other types of input devices may be used. The scope of the invention should, therefore, be determined not with reference to the above description, but instead should be determined with reference to the appended claims along with their full scope of equivalents.

What is claimed is:

1. A system of user manipulable devices for interfacing with a host device, the system comprising:
a first user manipulable device which is configured to be operatively connected with the host device to interface with the host device to transfer data between the first user manipulable device and the host device and produce sensory feedback to a user; and
a second user manipulable device which is configured to interface wirelessly with the first user manipulable device to transfer data between the second user manipulable device and the host device via the first user manipulable device and produce sensory feedback to the user, wherein the first user manipulable device and the second user manipulable device are manipulable by the same user.

2. The system of claim 1 wherein the first user manipulable device is configured to process the data received from the second user manipulable device and present the data of the first and second user manipulable devices to the host device as signals from a single device.

3. The system of claim 1 wherein the first and second user manipulable devices are game controller devices.

4. The system of claim 3 wherein the first user manipulable device comprises one of a wheel and a pedal apparatus, and the second user manipulable device comprises another one of the wheel and the pedal apparatus.

5. The system of claim 3 wherein the first user manipulable device comprises one of a joystick and a throttle, and the second user manipulable device comprises another one of the joystick and the throttle.

6. The system of claim 1 wherein the first user manipulable device is configured to be connected to the host device to receive power from the host device.

7. The system of claim 1 wherein the first user manipulable device is configured to be connected to the host device via a USB connection.

8. The system of claim 1 wherein the second user manipulable device is configured to interface wirelessly with the first user manipulable device by infrared, radio frequency, or ultrasound.

9. The system of claim 1 wherein the sensory feedback comprises at least one of visual feedback, audio feedback, and force feedback.

10. The system of claim 1 wherein the second user manipulable device is cordless.

11. A system of user manipulable devices for interfacing with a host device, the system comprising:
a first user manipulable device which is configured to be operatively connected with the host device to interface with the host device to transfer data between the first user manipulable device and the host device and produce sensory feedback to a user; and
a second user manipulable device which is configured to interface wirelessly with the first user manipulable device to transfer data between the second user manipulable device and the host device via the first user manipulable device and produce sensory feedback to the user, wherein the first user manipulable device and the second user manipulable device are game controller devices for playing a game in the host device by the user.

12. The system of claim 11 wherein the first user manipulable device is configured to be connected to the host device via a wired connection.

13. The system of claim 11 wherein the first user manipulable device is configured to be connected to the host device via a USB connection.

14. The system of claim 11 wherein the first user manipulable device is configured to process the data received from the second user manipulable device and present the data of the first and second user manipulable devices to the host device as signals from a single device.

15. The system of claim 11 wherein the first user manipulable device comprises one of a wheel and a pedal apparatus, and the second user manipulable device comprises another one of the wheel and the pedal apparatus.

16. The system of claim 11 wherein the first user manipulable device comprises one of a joystick and a throttle, and the second user manipulable device comprises another one of the joystick and the throttle.

17. A method of interfacing with a host device via a plurality of user manipulable devices, the method comprising:
transmitting data generated in a second user manipulable device by a user to a first user manipulable device wirelessly;
transmitting data generated in the first user manipulable device by the user and the data received from the second user manipulable to the host device via a wired connection between the first user manipulable device and the host device; and
processing the data received by the host device from the first user manipulable device via the wired connection to provide sensory feedback to the user.

18. The method of claim 17 further comprising processing the data received by the first manipulable device from the second user manipulable device and presenting the data of the first and second manipulable devices to the host device as signals from a single device.

19. The method of claim 17 wherein the first and second user manipulable devices are game controller devices which are manipulable by the same user.

20. The method of claim 17 further comprising transmitting power from the host device to the first user manipulable device.
